(19) United States
(12) Patent Application Publication
(10) Pub. No.: US 2009/0005204 A1
(43) Pub. Date: Jan. 1, 2009

(54) MECHANICAL SPEED REDUCER BY BELT

(75) Inventor: VALMOR DA CUNHA GRAVIO, POMPEIA (BR)

Correspondence Address: VALMOR DA CUNHA GRAVIO, RUA WASHINGTON LUIZ 601, POMPEIA - SP, 17580-00, BR

(73) Assignee: VALMOR DA CUNHA GRAVIO, Pompeia (BR)

(21) Appl. No.: 12/141,155

(22) Filed: Jun. 18, 2008

(30) Foreign Application Priority Data
Jun. 29, 2007 (BR) PI 0701380-9

(51) Int. Cl. B62M 9/02

(52) U.S. Cl. 474/146

(57) ABSTRACT

The present invention refers to a mechanism for mechanical speed reducer or overdrive in which for each reducing stage there are two pulleys or sprockets disposed laterally and in parallel position between themselves, moreover one of them in orbital motion provided by a eccentric cam reciprocal to the reducer input element and the other pulley or sprocket disposed at the same input element center and the torque transmission between the pulleys or sprockets is done through a belt.

### FIELD OF THE INVENTION

The present invention relates to a planetary gear mechanism used for speed reduction or overdrive and, in particular, to the use of one pulley or sprocket drivingly connected by a drive belt to another pulley or sprocket, where one of the pulley or sprocket is concentric with the input shaft and been laterally and parallel with the other pulley or sprocket which one has orbital motion provided by a eccentric cam reciprocal to the reducer input shaft.

### BACKGROUND OF THE INVENTION

Planetary or epicyclic gear systems for use in speed reducers are a long time known. One example of such system is described in U.S. Pat. No. 276,776, issued to George F. Clemons on May 1, 1883. There are known mechanisms of epicyclic speed reduction, which typically include a pinion gear in orbit coupled to an internally toothed gear. These transmissions make possible great speed reduction however there is the limiting factor, which is the precise aspect of the complicated teeth and the transmitted torque limitation due to the small contact area between the teeth of the gears. In other aspect mechanical speed reductions by belt and pulleys are widely used in machines, vehicles and household devices, etc. The constraint in the use of such transmissions performed by belt and pulleys for great reductions is in the relative size between the pulleys, what in some cases, leads to the various reduction stages.

### SUMMARY OF THE INVENTION

The present invention provides other possibility to use the idea of the planetary gear mechanism in a reduction gear or an overdrive gear, using pulleys or sprockets and belt. The great advantage of this type of pulley or sprocket for reducer or overdrive is the great transmission ratio reached in just one reduction or overdrive stage besides the very simple structure. The present invention uses pulleys or sprockets in which one of them has orbital motion in relation to the rotating center of the other. The pulleys or sprockets are disposed laterally and in parallel position between themselves, and the belt is wide enough to embrace simultaneously both pulleys doing the torque transference between the pulleys or sprockets. For this type of reducer can be applied regular belt as the “Poly-V” type or synchronous belt type, for instance, which makes possible low-cost construction.

The invention allows a variety of transmission ratios in compact sets with very few parts in a single stage or multiple stages for big reductions or overdrive.

These and others aspects of the present invention are herein described in particularized detail with reference to the accompanying Figures, as non-limited examples.

### BRIEF DESCRIPTION OF THE FIGURES

FIG. 1 presents a frontal view in a schematic representation of a didactic reducer model with one of the pulleys fixed to the reducer structure.

FIG. 2 presents the FIG. 1 model with the orbital motion pulley added of four pulling pins fixed to it.

FIG. 3 presents an overview in longitudinal cross-section of a reducer assembled on an engine according to FIG. 2, having the orbital pulley four cavities instead of four pins.

FIG. 4 presents a second reducer construction modality in which the orbital motion pulley has four cavities, which are inserted in the four pins fixed in the structure and the other pulley is the reducer output element.

FIG. 5 illustrates an overview in longitudinal cross-section of a construction possibility for the reducer model of FIG. 4 assembled on an engine.

FIG. 6 presents an overview in longitudinal cross-section of another construction possibility for a reducer model of FIG. 4 where the eccentric cam is part to the input element and the output shaft is supported on the reducer case.

FIG. 7 presents an overview in longitudinal cross-section of a reducer with double stage, using the two constructions modalities and synchronous belt.

### DESCRIPTION OF THE PREFERRED EMBODIMENTS

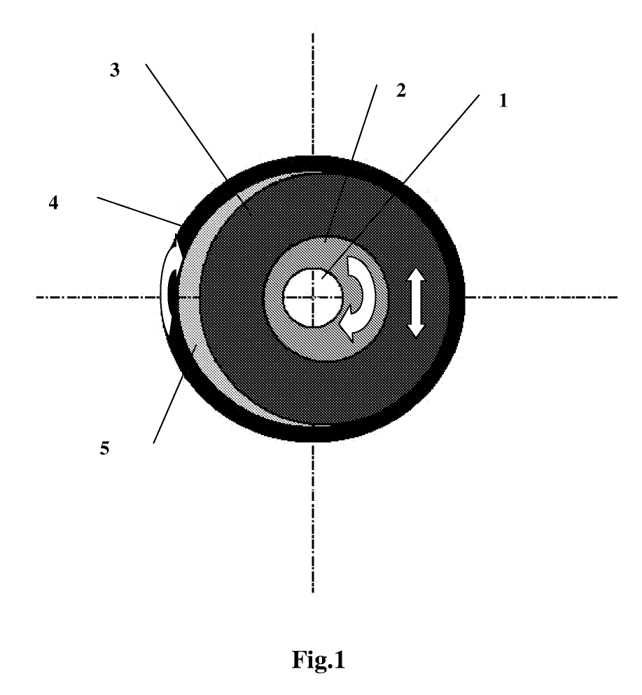

The functioning principle of such a reducer can be seen in FIG. 1 which is the first constructive modality where the rotational motion of the input element 1 makes the eccentric cam 2 moves in orbital motion which is reciprocal to input element 1 and moving, the eccentric cam 2 transmits the orbital motion to the pulley 3. The pulley 3 rotates in the eccentric cam 2. The belt 4 makes the drivingly coupling between the pulley 3 and the pulley 5. In this case, the pulley 5 is reciprocal to the reducer structure.

As represented in FIG. 1, the rotary motion of the input element 1 makes the pulley 3 drivingly coupled to the pulley 5 rotates. Without taking into account an eventual slipping between the pulley 3 and pulley 5 with the belt 4, the transmission relation between the rotation of the input element 1 and the pulley 3 is given by the pitch diameter of the pulley 3 divided by the difference between the pitch diameter of the pulley 3 and the pitch diameter of the pulley 5. One negative result means different rotation direction between input and output shaft. The lower difference between the pulley 5 and the pulley 3 pitch diameter higher the reduction.

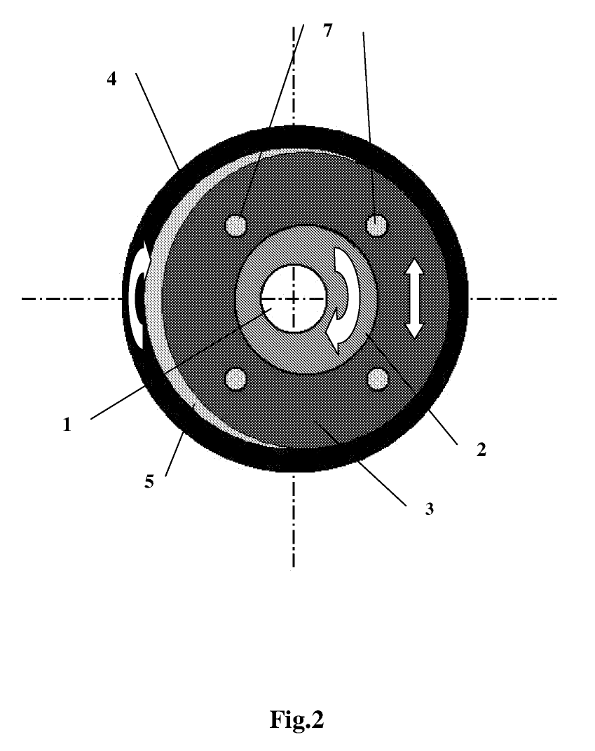

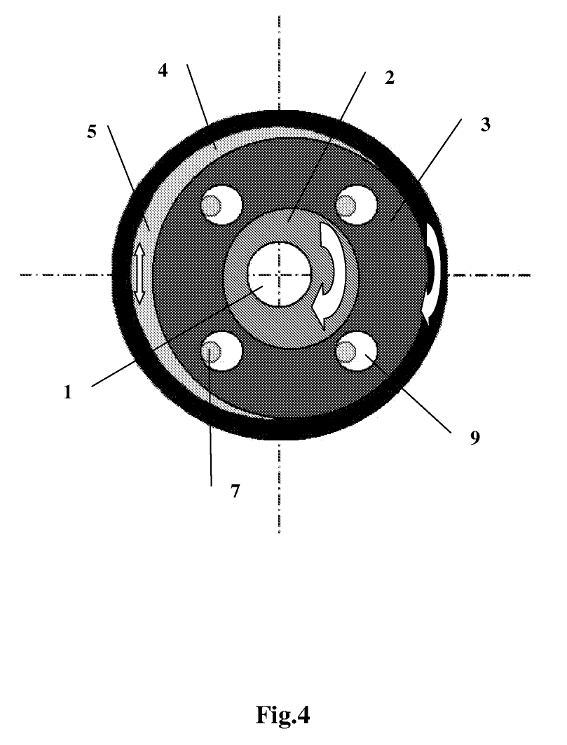

There are two constructive modalities for this reducer. In a first modality as represented in FIGS. 1 and 2 with the pulley 5 reciprocal to the reducer case and placed concentric with the input element 1. In this modality as there are orbital and rotational motion in the pulley 3, set on the eccentric cam 2, it is necessary a special coupling to transfer only rotational motion to the reducer output, since normally the orbital motion is not desirable. On a second constructive modality represented in FIG. 4, the pulley 3 is activated by the eccentric cam 2 motion and coupled to the case reducer in a way that the coupling allows only the orbital motion and not the rotary motion on the pulley 3. In this constructive modality the pulley 3 in orbital motion coupled to the case, it makes through the belt 4 the rotational motion of the pulley 5 which is placed on the same center of the input element 1 so the pulley 5 serve as a reducer output element.

In FIG. 2 we have the first constructive modality in which case the pulley 5 is reciprocal to the reducer structure and concentrically placed with the input element 1, and the pulley 3 is set on the eccentric cam 2 and it has, as an example, four pins 7 fixed to it, which make part of the coupling to transmit only rotational motion from the pulley 3, and not orbital motion, to an output element which rotates concentrically with the input element 1.

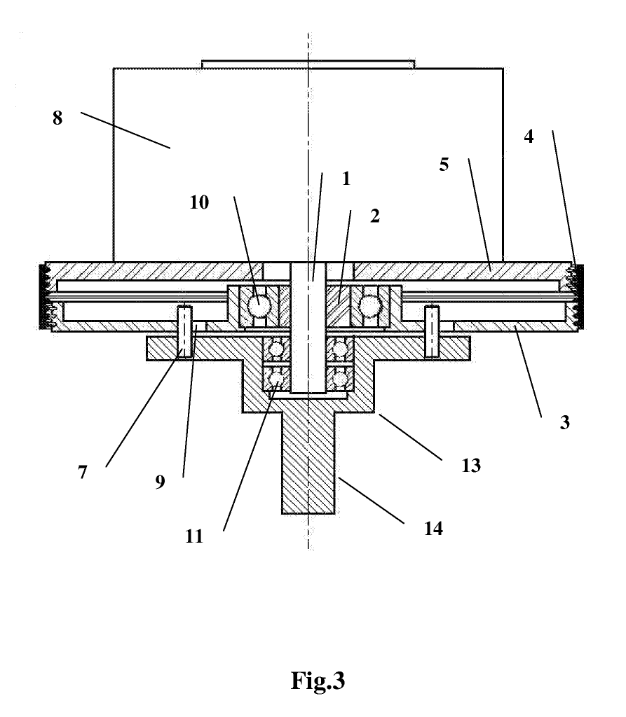

We have in FIG. 3 a longitudinal cross-section of a reducer assembled on an engine 8. This is a constructive possibility to the model of FIG. 2. In this construction the pulley 5 is reciprocal to the engine 8 case which also serves as reducer structure and the output of the reducer is done through the shaft 14 which belongs to the rotating element 13 which is coupled to the pulley 3 through the fitting of its four fixed pins 7 in the four cavities 9 of the pulley 3. Through this coupling of the four cavities 9 of pulley 3 with the four pins 7 of the rotating element 13 is transmitted from the rotational and orbital motion of the pulley 3 only a rotational motion to the rotating element 13. The cavities 9 have bigger diameter than the pins 7, the diameter of the cavity 9 is equal the diameter of the pins 7 more twofold the eccentricity of the eccentric cam 2. Therefore the power input in the reducer is done through the input element 1 of the engine 8 it has its output in the shaft 14 of the reducer.

We have in FIG. 4 the second constructive modality of the reducer where the pulley 5 rotates. The pulley 3 is coupled to the reducer structured, which in this example is done through the fitting of its four cavities 9 in the four pins 7 fixed in the reducer structure. In this case as in the former one the cavity diameter 9 is the sum of the pin 7 diameter added twofold the eccentricity of the eccentric cam 2 in relation with the input element 1. This coupling of the pulley 3 with the reducer structure only allows the orbital motion and eliminates the possibility of pulley 3 rotation around the same center of the input element 1. The rotary motion of the input element 1 and consequently the eccentric cam 2 reciprocal to it, produce an orbital motion on the pulley 3 which under the restriction of the rotation imposed by the four pins 7 fitted in the four cavities 9 and in contact with the belt 4, rotates the pulley 5. The rotation direction of the pulley 5 is opposite to the direction of the rotation of the input element 1 if its primitive diameter is smaller than the primitive diameter of the pulley 3. Not taking into account eventual slipping between the pulley 3 and the pulley 5 with the belt 4, the transmission relation for this second modality between the input element 1 and the external ring 5 is given by the pitch diameter the pulley 5 divided by the difference of the pitch diameters of the pulley 5 and the pulley 3.

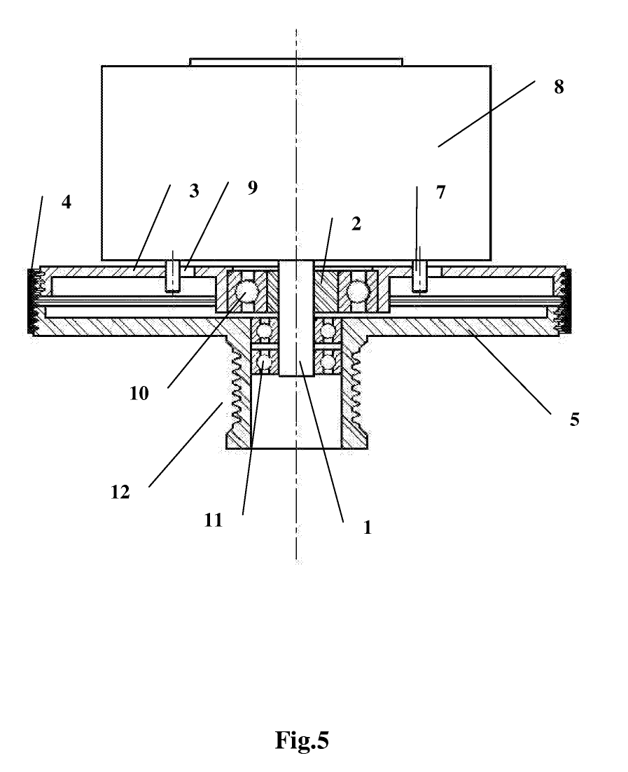

We have in FIG. 5 a longitudinal cross-section of reducer assembled on an engine 8. This reducer is the model of FIG. 4, where to improve the slipping between the eccentric cam 2 surfaces and the pulley 3 it was used a bearing 10. It was also used two bearings 11 between the input element 1 and the pulley 5, which in this case also has a pulley 12 as an integral part. The pulley 12 of the pulley 5 is only an example of a possibility of the reducer output power. In this example the pulley 3 is coupled to the engine 8 case, which also works as a reducer structure, being the coupling done through the suiting of the four pins 7 in the four cavities 9 of the pulley 3. The four pins 7 are fixed on the engine case.

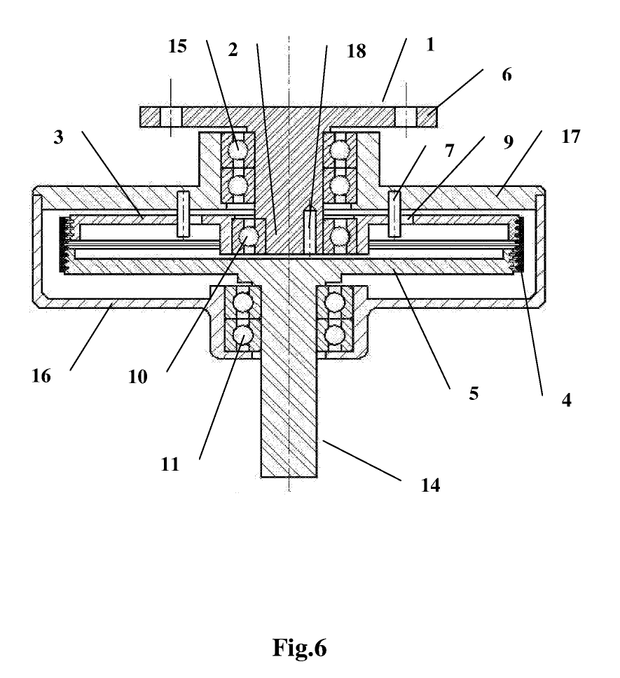

Another constructive possibility for this second reducer modality can be seen in FIG. 6 where the reducer input element 1 has the eccentric cam 2 as its integral part and, as an example, the entrance element 1 has a flange 6 for the power input connection. The pulley 5 is movable rotating on the bearings 11, which bearings 11 are supported on the case 16 and the reducer output power is done through the shaft 14, which is an integral part of the pulley 5. The pins 7 are fixed on the flange 17. So the rotation of the input element 1 with the eccentric cam 2 which is part of it moves the pulley 3 in orbital motion through the bearings 10. The pulley 3 is coupled to the reducer structure through the suiting of its four cavities 9 in the four pins 7, which only allow orbital motion and not rotational motion of the pulley 3 in relation with the axis of the input element 1. Therefore the pulley 3 transmits torque to the pulley 5 through the belt 4, making the pulley 5 to rotate. In the example of FIG. 6 the eccentric cam 2 has a relief hole 18 for balancing the unbalanced powers, which were generated by the orbital motion, therefore avoiding regular undesired vibrations. In some other cases, such holes for mass relief are not enough to balance the eccentric set, so it is necessary the use of, for example, a reciprocal counter-weight to the eccentric cam 2.

Generally these reducers are suitable for great transmission rates due to be necessary a bigger eccentricity for the eccentric can 2 for smaller ratios, considering for small transmission rates it may be an advantage to apply pulleys and belt in a conventional way.

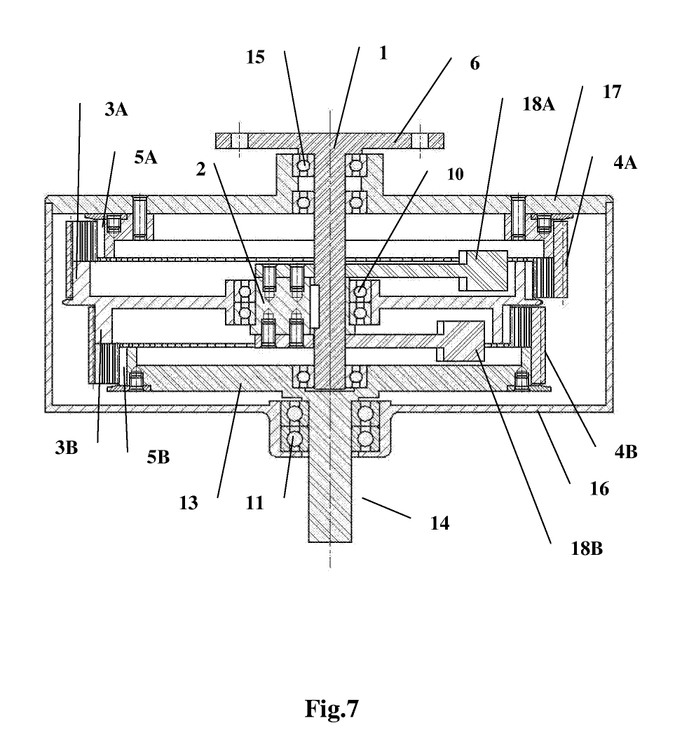

FIG. 7 presents a constructive possibility for the reducer using the two constructive modalities in one double stage reducer. This kind of double stage reducer increases the transmission ratios possibilities and avoids the coupling to the orbital pulley or sprocket. The first constructive modality is represented by the sprocket 5A reciprocal with the reducer case and the sprocket 3A has orbital motion and transfer his motion to the sprocket 3B which is reciprocal to it and the second constructive modality where the sprocket 3B has orbital motion and the sprocket 5B concentric with the input element 1 serves as output power. In this example, the sprockets and the belts are synchronous type; the input element 1 has the flange 6 for the input power. The sprocket 5A is reciprocal to the flange 17. The sprocket 5B rotates on the bearings 11, which bearings 11 are supported on the case 16 and the reducer output power is done through the shaft 14, which is an integral part of the sprocket 5B. In this example, the sprocket 3A has number of teeth different from the sprocket 3B. Due to the sprockets 3A and 3B are been set at the same eccentric cam 2, consequently each stage have the same eccentricity, the two reduction stages must have the same difference between the primitive diameter of each pair of sprockets, that is the difference of the primitive diameter of the sprockets 3A and 5A must be the same of the difference of the primitive diameter of the sprockets 3B and 5B. This way the rotation of the input element 1 moves the eccentric cam 2, which is reciprocal to it, which the eccentric cam 2 moves in orbital motion the sprockets 3A and 3B through two bearings 10. The orbital motion of the sprocket 3A brings rotation motion too for the sprocket 3A due to be coupled with the sprocket 5A by the belt 4A and transmit torque to the sprocket 3B which is reciprocal to it and the sprocket 3B with orbital and rotation motion too, transmit torque to the sprocket 5B by the belt 4B making the sprocket 5B to rotate. In this example of FIG. 7 the two counter-weights 18A and 18B are reciprocal with the eccentric cam 2 to minimize the unbalanced power raised by the orbital motion, therefore avoiding vibrations, which normally are undesirable.

This double stage reducer construction has infinite possibilities of transmission rates, depending of the primitive diameter of the sprockets. In many cases it can work to increase speed if the transmission rate is not so big. The rotation direction of the output shaft depends of the primitive diameter of the sprockets too. For example, if the sprockets 5A, 3A, 5B, 3B have respectively number of teeth 52, 53, 53, 52 the reducer will work as speed overdrive too and the transmission rate will be 1:26.75. If we change just the number of teeth of the sprocket 5B to 51 teeth, it will make the inversion of the rotation direction of the output shaft and the reducer will work just as speed reducer with transmission rate of 1:2703. Generally this speed reducer or overdrive is extremely compact compared to traditional belt transmissions.

Another aspect to be taken into account in this type of reducer, is the power to be transmitted by the belt which is different from the conventional ones, since the pulleys are coupled to just one part of the belt width in opposite sides, which are different from the traditional ones where each pulley is coupled to the whole belt width.

All the shown examples herein, of such a reducer, can be set sequentially in various reducing stages through coupling of reducers or performed by a construction of a reducer with various reducing stages on the same case.

What is claimed is:

1. Mechanical speed reducer by belt, in which for each reducing stage there is the input power made through an input element 1,
an eccentric cam 2 which is reciprocal to the input element 1 or it is part of the input element 1,
a pulley or sprocket 3 which rotates in the eccentric cam 2 through bearings, sleeves, etc or directly through sliding contact, and
a pulley or sprocket 5 which is concentric with the input element 1 beside and in parallel position to the pulley or sprocket 3 and
the torque transmission between the pulley or sprocket 3 and the pulley or sprocket 5 is done by belt

2. Mechanical speed reducer by belt, of claim 1 wherein the pulley or sprocket 5 is reciprocal to the reducer structure and
the pulley or sprocket 3 is set in the eccentric cam 2 in which the pulley or sprocket 3 serves as the reducer output or it is coupled to the rotating element 13
which rotating element 13 is supported in the input element 1 or on the reducer case concentric with the input element 1 through bearings, sleeves, etc or directly through sliding contact, through which the rotating element 13 serves as the reducer output.

3. Mechanical speed reducer by belt of claim 1, wherein the pulley or sprocket 3 is set in the eccentric cam 2 coupled to the reducer structure,
which allows only the orbital motion or is reciprocal or coupled with other pulley or sprocket 3 of the another reduction stage and
the pulley or sprocket 5 rotates concentrically with the input element 1 supported in the same input element 1 or on the case 16 of the reducer through bearings, sleeves, etc or directly through sliding contact, by which the pulley or sprocket 5 serves as the reducer output power.
